(19) United States
(12) Patent Application Publication
(10) Pub. No.: US 2026/0025724 A1
(43) Pub. Date: Jan. 22, 2026

(54) TIME QUALITY DELIVERY IN WIRELESS COMMUNICATION

(71) Applicant: ZTE Corporation, Shenzhen (CN)

(72) Inventors: Zhuang LIU, Shenzhen (CN); Man ZHANG, Shenzhen (CN); Dapeng LI, Shenzhen (CN); Yin GAO, Shenzhen (CN)

(21) Appl. No.: 19/345,837

(22) Filed: Sep. 30, 2025

Related U.S. Application Data
(63) Continuation of application No. PCT/CN2023/085994, filed on Apr. 3, 2023.

(51) Int. Cl. H04W 36/08; H04L 5/00; H04W 56/00

(52) U.S. Cl. CPC H04W 36/08; H04L 5/0053; H04W 56/0015

(57) ABSTRACT

Time synchronization can be maintained during mobility of the UE by utilizing communications with a target base station. The target base station may receive a time delivery configuration or a time delivery area from the network. The time delivery configuration or a time delivery area is used to determine a delivery of time quality information, which can be utilized by the UE.

### CROSS-REFERENCE TO RELATED APPLICATION

This application is a continuation and claims priority to International Application No. PCT/CN2023/085994, filed on Apr. 3, 2023, the disclosure of which is hereby incorporated by reference herein in its entirety.

### TECHNICAL FIELD

This document is directed generally to wireless communications. More specifically, time synchronization is provided for devices on a network.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, improvements should be made to maintain and ensure the quality of service standards.

### SUMMARY

This document relates to methods, systems, and devices for time synchronization between a network and user equipment (UE). Time synchronization can be maintained during mobility of the UE by utilizing communications with the target base station. The target base station may receive a time delivery configuration or a time delivery area from the network. The time delivery configuration or a time delivery area is used to determine a delivery of time quality information, which can be utilized by the UE.

In one embodiment, a wireless communication method includes receiving, at a target base station, a time delivery configuration; and determining, by the target base station, a delivery of time quality information based on the time delivery configuration. The delivery of time quality information is to a user equipment (UE). The receiving is during UE handover procedure or base station path switching procedure for UE handover. The time delivery configuration is transmitted from a source base station or a core network (CN). The time delivery configuration includes a clock quality acceptance criteria; and/or a clock quality level. A user equipment (UE) can determine whether it needs to switch to another clock source or whether a current value of the clock quality level meets requirements of ongoing time-sensitive services. The clock quality acceptance criteria comprises a parent time source, a traceability to Coordinated Universal Time (UTC) or Global navigation satellite system (GNSS), a synchronization state, a clock accuracy, or a frequency stability. The clock quality level comprises clock quality metrics or an indication for acceptance, wherein the clock quality level indicates what to provide to a user equipment (UE). The indication for acceptance indicates a current timing synchronization status based on the clock quality acceptance criteria. A bit string indicates one or more clock quality metrics to be reported to the UE, wherein each position in a bitmap indicates which of the clock quality metrics is needed. The method includes sending, by a source base station, a handover required message to a core network (CN) that includes the time delivery configuration; and receiving, at the target base station, the time delivery configuration provided by the source base station in a handover request message sent by the CN. The method includes after receiving a handover required message or path switch request message, determining the time delivery configuration, by a core network (CN); and receiving, at the target base station, the time delivery configuration from the CN included in a handover request message or a path switch acknowledge message. The method includes sending, by a source base station, a handover request message that includes the time delivery configuration; and receiving, at the target base station from the source base station, the time delivery configuration. A core network (CN) provides the time delivery configuration to a source base station before the receiving at the target base station. The method includes receiving, from a core network (CN), an NG Application Protocol (NGAP) message that includes a time delivery start or stop indication for a user equipment (UE), wherein the start or stop indication activates or deactivates a function of time quality delivery for the UE.

In another embodiment, a wireless communication method includes receiving, at a target base station, a time delivery area; and determining, by the target base station, a delivery of time quality information based on the time delivery area. The delivery of time quality information is to a user equipment (UE). The receiving is during a handover procedure of the UE or during a base station path switching procedure for the UE handover procedure. The time delivery area is transmitted from a source base station or a core network (CN). The time delivery area includes a list of tracking area; a list of cells; a list of Standalone Non-Public Network (SNPN); or a list of closed access groups (CAG) for integrated non-public networks. The method includes sending time quality information to a user equipment (UE) when the UE is in a coverage area indicated by the time delivery area. The method includes sending, by a source base station, a handover required message to a core network (CN) that includes the time delivery area; and receiving, at the target base station, the time delivery area provided by the source base station in a handover request message sent by the CN. The method includes after receiving a handover required message or path switch request message, determining the time delivery area, by a core network (CN); and receiving, at the target base station, the time delivery area from the CN included in a handover request message or path switch acknowledge message. The method includes sending, by a source base station, a handover request message that includes the time delivery area; and receiving, at the target base station from a source base station, the time delivery area. A core network (CN) provides the time delivery area to the source base station before the receiving at the target base station. The method includes receiving, from a core network (CN), an NG Application Protocol (NGAP) message that includes a time delivery start or stop indication for a user equipment (UE), wherein the start or stop indication activates or deactivates a function of time quality delivery for the UE. In another embodiment, a wireless communications apparatus comprising a processor and a memory, wherein the processor is configured to read code from the memory and implement any of the methods for wireless communication described herein.

In another embodiment, a wireless communications apparatus comprises a processor and a memory, and the processor is configured to read code from the memory and implement any of the embodiments discussed above.

In another embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example base station.

FIG. 2 shows an example random access (RA) messaging environment.

FIG. 3 shows an embodiment of a wireless network system architecture.

FIG. 4 shows example time delivery configuration information.

FIG. 5 shows example time delivery area information.

FIG. 6 shows an embodiment for a network providing information to the base station for time synchronization.

FIG. 7 shows an embodiment for a network updating information to the base station for time synchronization.

FIG. 8 shows an embodiment for time quality delivery during a handover.

FIG. 9 shows another embodiment for time quality delivery during a handover with storage of information by the network.

FIG. 10 shows an embodiment for a continuity of time quality deliver during handover.

FIG. 11 shows another embodiment for a continuity of time quality deliver during handover with storage of information by the network.

FIG. 12 shows an embodiment for starting/stopping of time delivery to user equipment (UE).

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the base station at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The base station or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

New Radio Access (“NR”) includes the ability to have time synchronization. Time synchronization between a network and user equipment (UE) and be more efficient by considering the time synchronization area of the UE. The time synchronization area is where the UE can receive on demand time synchronization. When the time synchronization area is communicated, such as through a notification or indication, a time synchronization signal can be sent only when the UE is in the area. A time synchronization indication may be used during a handover

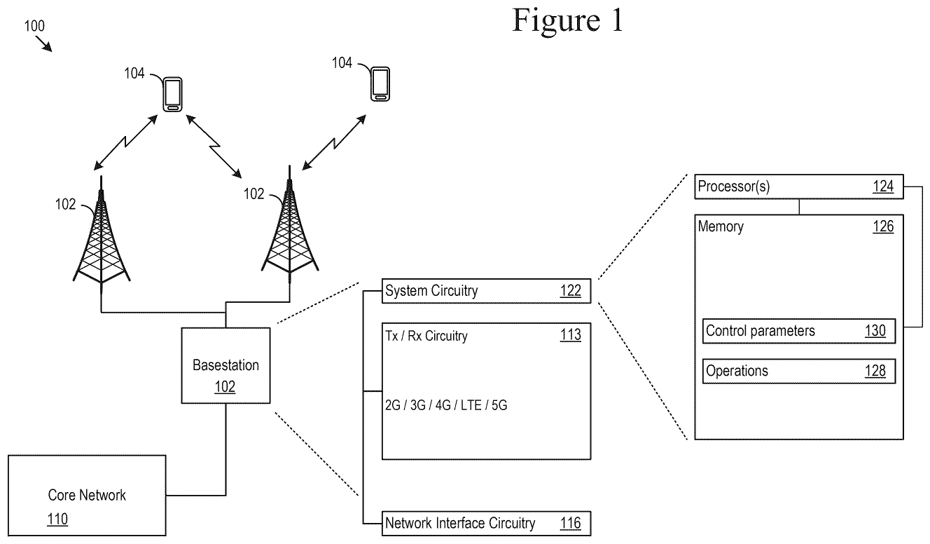

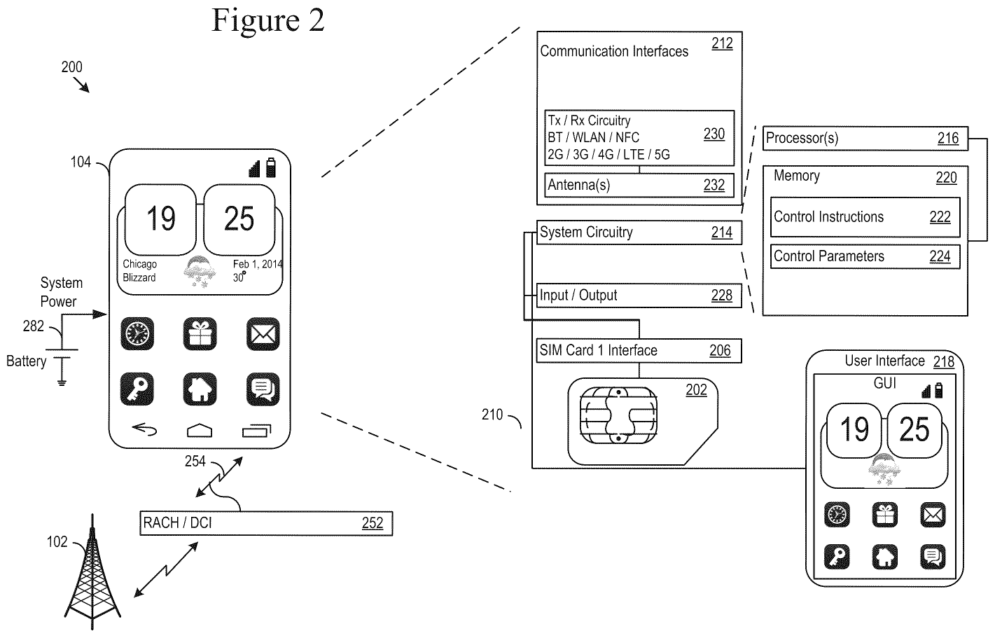

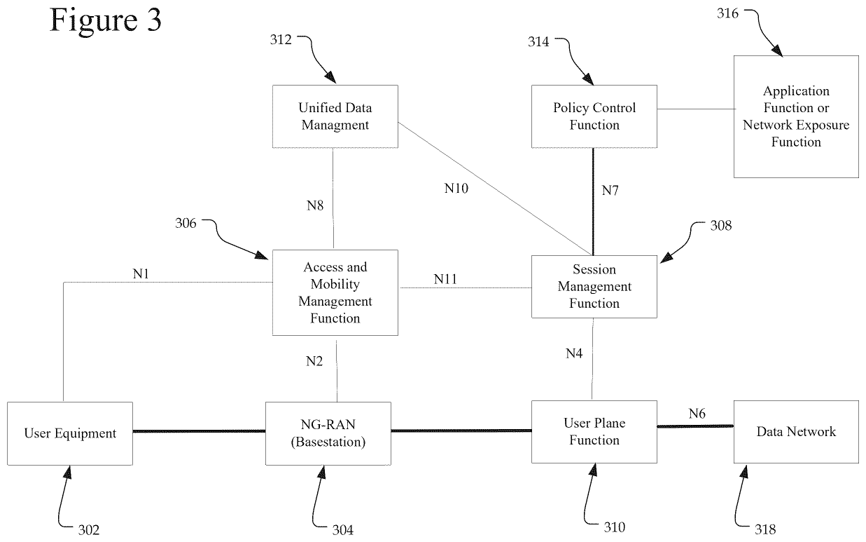

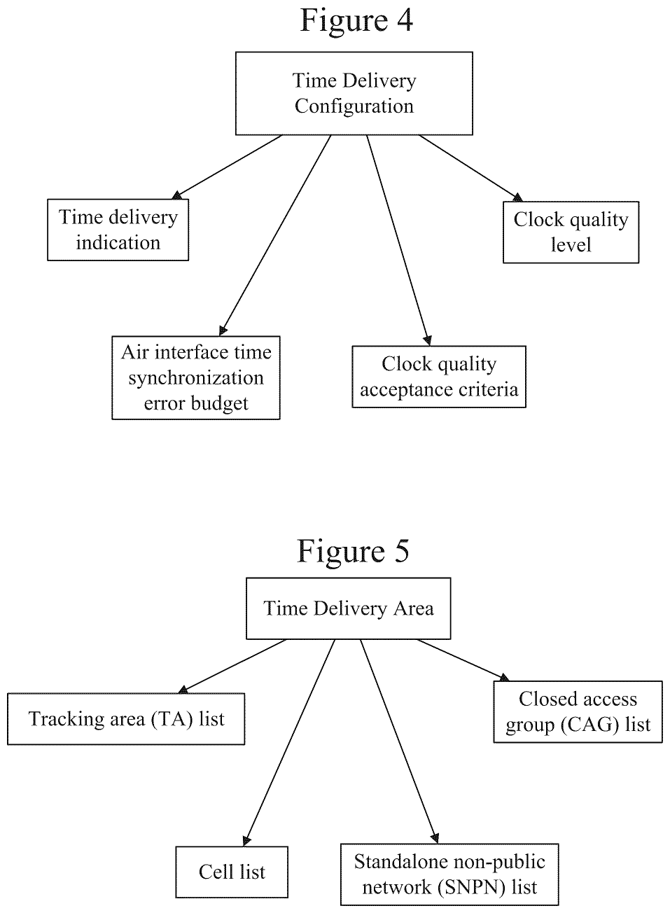

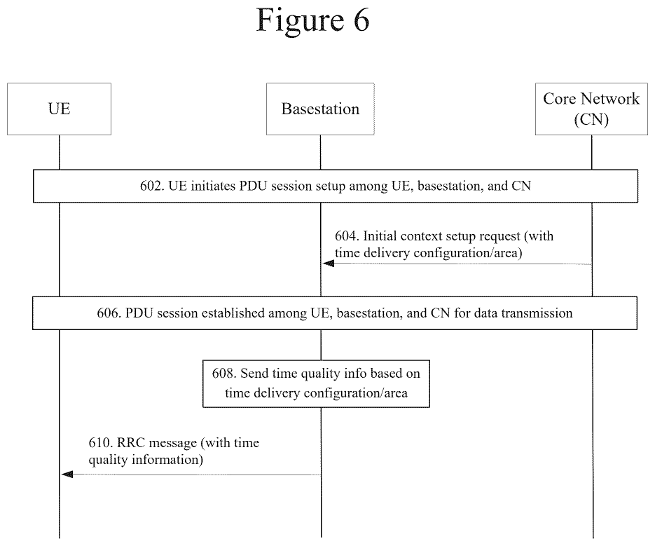

There may be different ways to provide a time synchronization service to devices (e.g. user equipment). The time synchronization signal may be referred to as access stratum time distribution. Access stratum time distribution may be deployed from a pre-configured Radio Access Network (RAN) nodes. The user equipment (UE) in an area may receive the precision time information when within the RAN coverage. When UE leave the area, the time synchronization signal may be area limited and no longer have access. The embodiments described below allow for a transmission of the time synchronization area for more efficient time synchronization distribution. In addition, UE's that have mobility (e.g. handover) can also have time synchronization. The RAN may be a part of a wireless communication system that connects UE devices to other parts of a network through radio or wireless connections. FIG. 1 illustrates an example NG-RAN or base station. FIG. 2 illustrates an example random access messaging environment. FIG. 3 illustrates an example architecture for the time synchronization signaling. FIGS. 6-12 illustrate wireless communication examples for improved time synchronization using information from FIGS. 4-5.

FIG. 1 shows an example base station 102. The base station 102 may also be referred to as a wireless network node or a next generation radio access network (“NG-RAN”) node. The base station 102 may be further identified to as a nodeB (NB, e.g., an eNB or gNB) in a mobile telecommunications context. The example base station may include radio Tx/Rx circuitry 113 to receive and transmit with user equipment (UEs) 104. The base station may also include network interface circuitry 116 to couple the base station to the core network 110, e.g., optical or wireline interconnects, Ethernet, and/or other data transmission mediums/protocols.

The base station may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the base station. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a base station 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

FIG. 3 shows one embodiment of a wireless network system architecture. This architecture is merely one example and there may be more or fewer components for implementing the embodiments described herein. The interconnections or communications between components are identified as N1, N2, N4, N6, N7, N8, N10, and N11, which may be referred to in the description or by other Figures. FIG. 2 illustrated an example user equipment (“UE”) 104. UE 302 is a device accessing a wireless network (e.g. 5GS) and obtaining service via a NG-RAN node or base station 304. The UE 302 interacts with an Access and Mobility Control Function (“AMF”) 306 of the core network via NAS signaling. FIG. 1 illustrates an example base station or NG-RAN 102. The NG-RAN node 304 is responsible for the air interface resource scheduling and air interface connection management of the network to which the UE accesses. The base station 304 may also be referred to as a next generation radio access network (“NG-RAN”) node and can provide a time synchronization signal to user equipment (UE). The time synchronization signal may be through a System Information Block (SIB) or through a Radio Resource Control (RRC) message.

The AMF 306 includes the following functionalities: Registration management, Connection management, Reachability management and Mobility Management. The AMF 306 also perform the access authentication and access authorization. The AMF 306 is the NAS security termination and relay the session management NAS between the UE 302 and the SMF 308, etc.

The SMF 308 includes the following functionalities: Session Management e.g. Session establishment, modify and release, UE IP address allocation & management (including optional Authorization), Selection and control of uplink function, downlink data notification, etc. The user plane function (“UPF”) 310 includes the following functionalities: Anchor point for Intra-/Inter-RAT mobility, Packet routing & forwarding, Traffic usage reporting, QoS handling for user plane, downlink packet buffering and downlink data notification triggering, etc. The Unified Data Management (“UDM”) 312 manages the subscription profile for the UEs. The subscription includes the data used for mobility management (e.g. restricted area), session management (e.g. QoS profile). The subscription data also includes slice selection parameters, which are used for AMF 306 to select a proper SMF 308. The AMF 306 and SMF 308 get the subscription from the UDM 312. The subscription data may be stored in a Unified Data Repository with the UDM 312, which uses such data upon reception of request from AMF 306 or SMF 308. The Policy Control Function (“PCF”) 314 includes the following functionality: supporting unified policy framework to govern network behavior, providing policy rules to control plane function(s) to enforce the policy rule, and implementing a front end to access subscription information relevant for policy decisions in the User Data Repository. The Network Exposure Function (“NEF”) 316 is deployed optionally for exchanging information with an external third party. In one embodiment, an Application Function (“AF”) 316 may store the application information in the Unified Data Repository via NEF. The UPF 310 communicates with the data network 318.

When the time synchronization service is configured for a UE, the NG-RAN (Next Generation Radio Access Network) or base station may need to provide the precise time information and network time synchronization status (e.g., clock quality level) to the UE. The precise time information sent to the UE can be generated by the NG-RAN based on the time source used in the NG-RAN, which may receive its clock information from the Global Navigation Satellite System (GNSS) receiver. Alternatively, the time source in 5G may be general precision time protocol (gPTP), or IEEE Standard for a Precision Clock Synchronization Protocol (IEEE Std 1588). The clock quality level of these time sources may also be provided to UE as part of the network time synchronization status.

When the user equipment (UE) subscribes to a time synchronization service in a certain area, the network may need to ensure that the UE can continuously receive time synchronization service in a specified area during the mobility of the UE. In some embodiments, the target base station may not know whether the UE can access the time synchronization service. Accordingly, communication of configuration of time information or time delivery area may be utilized to maintain the time synchronization service of the UE.

FIGS. 4-5 illustrate example information that may be communicated for maintaining time synchronization for user equipment (UE). FIG. 4 shows example time delivery configuration information. Time delivery configuration may include a time delivery indication that indicates the need for providing timing information to the UE. Time delivery configuration may include an air interface time synchronization error budget. The UE may use this value to evaluate the correct time. Time delivery configuration may include clock quality acceptance criteria. This criteria may be defined based at least one of the following attributes: parent time source, traceability to UTC and/or to GNSS, synchronization state, clock accuracy, and/or frequency stability. Time delivery configuration may include a clock quality level report type that indicates whether and which clock quality information to provide to the UE. It may include clock quality metrics or an acceptable/not acceptable indication. The clock quality metrics may be used to reflect current base station timing synchronization status. The metrics may include at least one of the following information: clock accuracy, traceability to UTC and to GNSS, frequency stability, parent time source, synchronization state; and/or acceptable indication is to indicate the current timing synchronization status matches the clock quality acceptance criteria.

The following table includes an example for the Time Delivery Configuration information for the UE. As described, the base station may provide time quality information to UE based on the time delivery configuration information. In the table, a BIT STRING may be used to indicate one or more clock quality metrics that need to be reported to UE, and each position in the bitmap indicates whether one type of metric is needed.

TABLE 1
Time delivery configuration information example.

| | IE type and | |
|---|---|---|
| IE/Group Name | reference | Semantics description |
| CHOICE Report Type of | | |
| Clock Quality | | |
| −> Clock Quality Metrics | | |
| Based | | |
| −>> Clock Quality Metrics | BIT STRING | This IE indicates that one or more clock quality |
| | (SIZE(16)) | metrics need to be reported to UE. Each position |
| | | in the bitmap indicates one type of metric. |
| | | First bit = clock accuracy, |
| | | Second bit = traceability to UTC, |
| | | Third bit = traceability to GNSS, |
| | | Fourth bit =frequency stability, |
| | | Fifth bit = parent time source, |
| | | Sixth bit = synchronization state, |
| | | other bits are reserved for future use. Value ‘1’ |
| | | indicates ‘metric needed’. Value ‘O’ indicates |
| | | ‘metric not needed”. |
| −> Acceptable Indication | | |
| Based | | |
| −>> Clock Quality | | the thresholds for one or more clock quality |
| Acceptance Criteria | | metrics |

FIG. 5 shows example time delivery area information. Time delivery area can provide the timing information to the UE when the UE is in a particular coverage area. This may include a list of tracking area (TA), a list of cells, a list of Standalone Non-Public Network (SNPN), and/or a list of Closed Access Group (CAG) for an Integrated Non-Public Network.

FIG. 6 shows an embodiment for a network providing information to the base station for time synchronization. In block 602, the user equipment (UE) triggers an initial packet data unit (PDU) session setup procedure. The session may be between the UE, the base station, and the core network (CN). In block 604, the Access and Mobility Control Function (AMF) sends a context setup message (e.g. INITIAL CONTEXT SETUP REQUEST) to the base station. The context setup message requests setup of the UE context. This message may include the time delivery configuration and/or the time delivery area information described with respect to FIGS. 4-5. In block 606, the PDU session is successfully established among the UE, the base station, and the CN. The UE can receive or transmit data to/from the base station. In block 608, the time delivery configuration and/or the time delivery area information described with respect to FIGS. 4-5 is used for determining when to send time quality information. For example, when the UE connection is first established and the UE enters into a connected state (e.g. RRC CONNECTED), when the current time synchronization status of the base station is changed, when the base station determines the clock quality metrics for the UE, whether clock quality is acceptable for the UE, and/or when the UE is in the coverage area indicated by the time delivery area, the base station decides to send the time quality information to the UE. The time quality information may include at least one of: an air interface time synchronization error budget or a clock quality level. In block 610, the base station sends a message (e.g. RRC message) to the UE that includes the time quality information in the message.

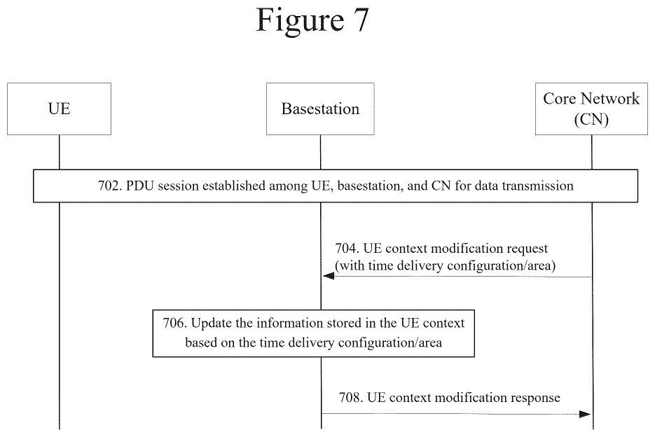

FIG. 7 shows an embodiment for a network updating information to the base station for time synchronization. In block 702, one or more sessions (e.g. PDU session) are successfully established between the UE, the base station, and the core network (CN). In block 704, a context modification message (e.g. UE CONTEXT MODIFICATION REQUEST) may include the time delivery configuration and/or the time delivery area information described with respect to FIGS. 4-5. The CN may use new time delivery configuration and/or the time delivery area information for the UE. The CN sends the context modification request message to the base station to request a modification of the UE context. In block 706, upon receipt of the updated time delivery configuration and/or the time delivery area information of the UE, the base station updates the information in the stored UE context. In block 708, the base station sends a context modification response (e.g. UE CONTEXT MODIFICATION RESPONSE) to the CN.

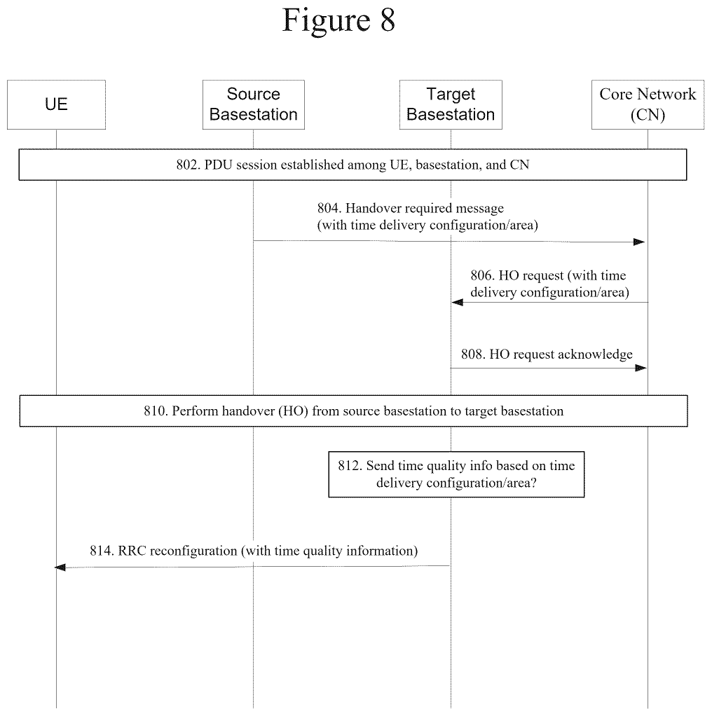

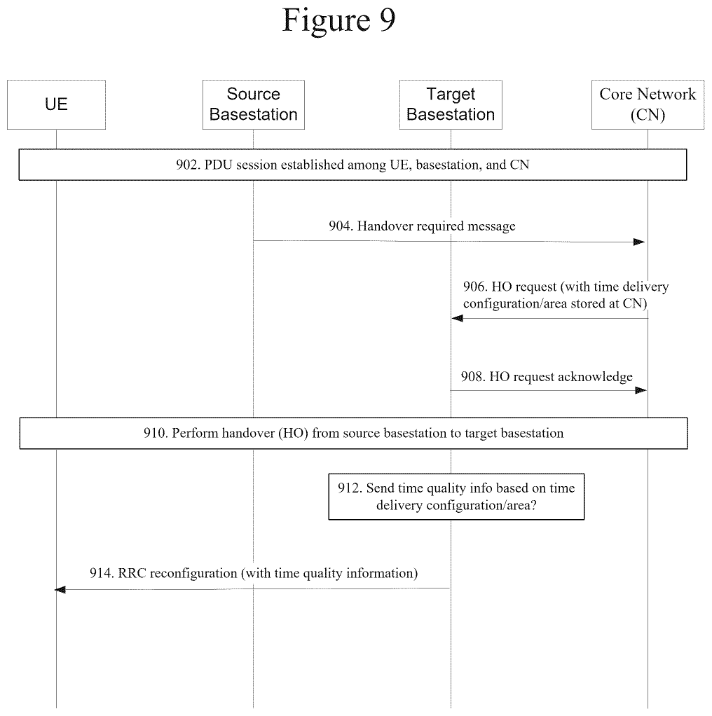

FIG. 8 shows an embodiment for time quality delivery during a handover. FIG. 9 illustrates an alternative embodiment in which the CN stores information as discussed below. Both embodiments support the continuity of time quality delivery to the UE during a handover. In block 802, the UE connects with the source base station. In block 804, the source base station determines a target base station for handover. This determination may be during UE mobility. If there is no interface connection (e.g. Xn interface) between the source base station and the target base station, the source base station may send a handover message (e.g. HANDOVER REQUIRED) to the core network (CN) for requesting handover to the target base station. This handover message to the CN in block 804 may include the time delivery configuration and/or the time delivery area information described with respect to FIGS. 4-5.

After receiving the handover message (e.g. the HANDOVER REQUIRED message), the CN sends a handover request message (e.g. a HANDOVER REQUEST message via the NG interface) to the target base station to request a resource for the UE at the target base station in block 806. This message includes the time delivery configuration and/or the time delivery area information for the UE. In block 808, if the target base station can accept the handover, the target base station sends an acknowledgment message (e.g. a HANDOVER REQUEST ACKNOWLEDGE message) to the CN. In block 810, the handover is performed from the source base station to the target base station.

The time delivery configuration and/or the time delivery area information is used for determining when to send time quality information in block 812. For example, the determination may be: after handover, when the current time synchronization status of the base station is changed, when the base station determines the clock quality metrics for the UE, whether clock quality is acceptable for the UE, and/or when the UE is in the coverage area indicated by the time delivery area, then the base station decides to send the time quality information to the UE. The time quality information may include at least one of: an air interface time synchronization error budget or a clock quality level. In block 814, the target base station sends a message (e.g. RRC message) to the UE that includes the time quality information in the message. Based on the received time quality information, the UE can determine whether it needs to switch to another clock source or whether the current time quality meets the requirements of ongoing time-sensitive services.

FIG. 9 shows another embodiment for time quality delivery during a handover with storage of information by the network. In FIG. 9, the core network (CN) stores the time delivery configuration and/or the time delivery area information described with respect to FIGS. 4-5, rather than that information being transmitted with the handover required message to the CN from the source base station as in the FIG. 8 embodiment. In this embodiment, the CN can transfer this stored information directly to the target base station.

In block 902, the UE connects with the source base station. In block 904, the source base station determines a target base station for handover. This determination may be during UE mobility. If there is no interface connection (e.g. Xn interface) between the source base station and the target base station, the source base station may send a handover message (e.g. HANDOVER REQUIRED) to the core network (CN) for requesting handover to the target base station. In this embodiment, this message does not include the time delivery configuration and/or the time delivery area information which is stored by the CN.

After receiving the handover message (e.g. the HANDOVER REQUIRED message), the CN sends a handover request message (e.g. a HANDOVER REQUEST message via the NG interface) to the target base station to request a resource for the UE at the target base station in block 906. This message includes the time delivery configuration and/or the time delivery area information for the UE that was stored by the CN. In block 908, if the target base station can accept the handover, the target base station sends an acknowledgment message (e.g. a HANDOVER REQUEST ACKNOWLEDGE message) to the CN. In block 910, the handover is performed from the source base station to the target base station.

The time delivery configuration and/or the time delivery area information is used for determining when to send time quality information in block 912. For example, the determination may be: after handover, when the current time synchronization status of the base station is changed, when the base station determines the clock quality metrics for the UE, whether clock quality is acceptable for the UE, and/or when the UE is in the coverage area indicated by the time delivery area, then the base station decides to send the time quality information to the UE. The time quality information may include at least one of: an air interface time synchronization error budget or a clock quality level. In block 914, the target base station sends a message (e.g. RRC message) to the UE that includes the time quality information in the message. Based on the received time quality information, the UE can determine whether it needs to switch to another clock source or whether the current time quality meets the requirements of ongoing time-sensitive services.

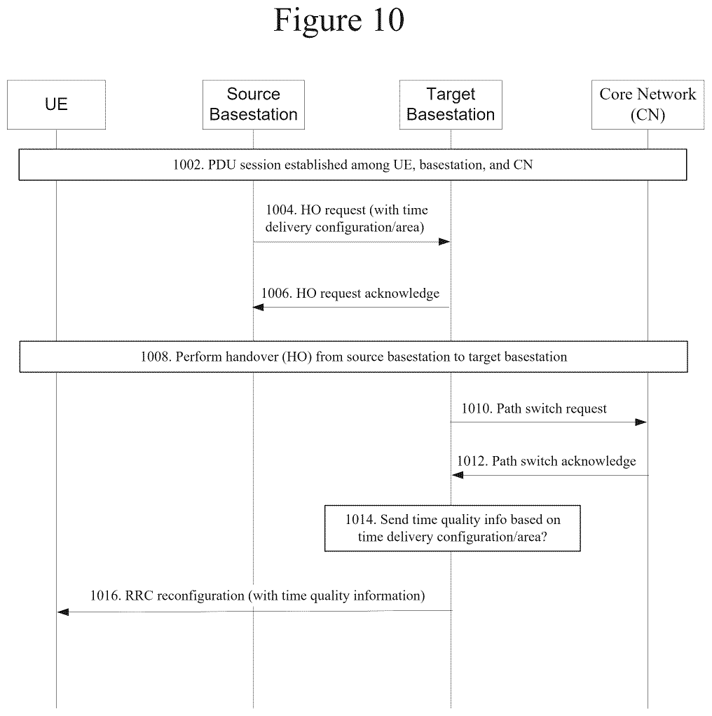

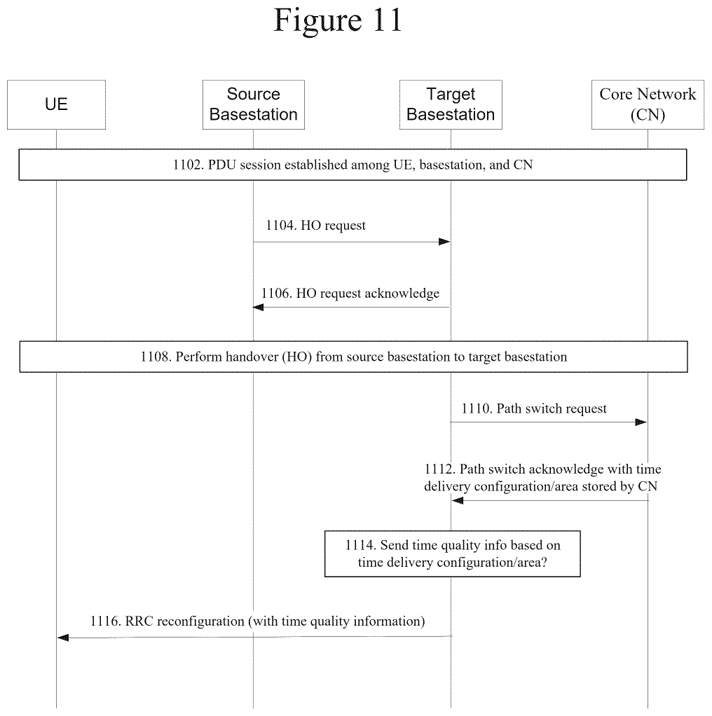

FIG. 10 shows an embodiment for a continuity of time quality deliver during handover. FIG. 11 illustrates an alternative embodiment in which the CN stores information as discussed below. Both embodiments support the continuity of time quality delivery to the UE during a handover. In block 1002, the UE connects with the source base station. The source base station determines a target base station for handover in block 1004. This determination is during UE mobility. If there is an interface connection (Xn interface) between the source base station and the target base station, then the source base station sends a handover request message (e.g. HANDOVER REQUEST message) to the base station for requesting handover of the UE to the target base station. This handover request message includes the time delivery configuration and/or the time delivery area information described with respect to FIGS. 4-5. In block 1006, if the target base station can accept the handover, the target base station sends a handover acknowledge message (e.g. HANDOVER REQUEST ACKNOWLEDGE message) to the source base station. In block 1008, the handover is performed from the source base station to the target base station.

After handover, the target base station sends a path switch message (e.g. PATH SWITCH REQUEST message) to the CN to inform the new serving base station in block 1010. In block 1012, the CN sends a path switch acknowledge message (e.g. PATH SWITCH REQUEST ACKNOWLEDGE message) to the target base station. The time delivery configuration and/or the time delivery area information is used for determining when to send time quality information in block 1014. For example, the determination may be: after handover, when the current time synchronization status of the base station is changed, when the base station determines the clock quality metrics for the UE, whether clock quality is acceptable for the UE, and/or when the UE is in the coverage area indicated by the time delivery area, then the base station decides to send the time quality information to the UE. The time quality information may include at least one of: an air interface time synchronization error budget or a clock quality level. In block 1016, the target base station sends a message (e.g. RRC message) to the UE that includes the time quality information in the message. Based on the received time quality information, the UE can determine whether it needs to switch to another clock source or whether the current time quality meets the requirements of ongoing time-sensitive services.

FIG. 11 shows another embodiment for a continuity of time quality deliver during handover with storage of information by the network. In FIG. 11, the core network (CN) stores the time delivery configuration and/or the time delivery area information described with respect to FIGS. 4-5, rather than that information being transmitted with the handover request message as in the FIG. 10 embodiment. In this embodiment, the CN can transfer this stored information to the target base station in a path switch acknowledge message.

In block 1102, the UE connects with the source base station. The source base station determines a target base station for handover in block 1104. This determination is during UE mobility. If there is an interface connection (Xn interface) between the source base station and the target base station, then the source base station sends a handover request message (e.g. HANDOVER REQUEST message) to the base station for requesting handover of the UE to the target base station. In this embodiment, this message does not include the time delivery configuration and/or the time delivery area information which is stored by the CN. In block 1106, if the target base station can accept the handover, the target base station sends a handover acknowledge message (e.g. HANDOVER REQUEST ACKNOWLEDGE message) to the source base station. In block 1108, the handover is performed from the source base station to the target base station.

After handover, the target base station sends a path switch message (e.g. PATH SWITCH REQUEST message) to the CN to inform the new serving base station in block 1110. In block 1112, the CN sends a path switch acknowledge message (e.g. PATH SWITCH REQUEST ACKNOWLEDGE message) to the target base station. In this embodiment, the core network (CN) stores the time delivery configuration and/or the time delivery area information described with respect to FIGS. 4-5 and that information is then included with the path switch acknowledge message (e.g. PATH SWITCH REQUEST ACKNOWLEDGE message) to the target base station in block 1112.

The time delivery configuration and/or the time delivery area information is used for determining when to send time quality information in block 1114. For example, the determination may be: after handover, when the current time synchronization status of the base station is changed, when the base station determines the clock quality metrics for the UE, whether clock quality is acceptable for the UE, and/or when the UE is in the coverage area indicated by the time delivery area, then the base station decides to send the time quality information to the UE. The time quality information may include at least one of: an air interface time synchronization error budget or a clock quality level. In block 1116, the target base station sends a message (e.g. RRC message) to the UE that includes the time quality information in the message. Based on the received time quality information, the UE can determine whether it needs to switch to another clock source or whether the current time quality meets the requirements of ongoing time-sensitive services.

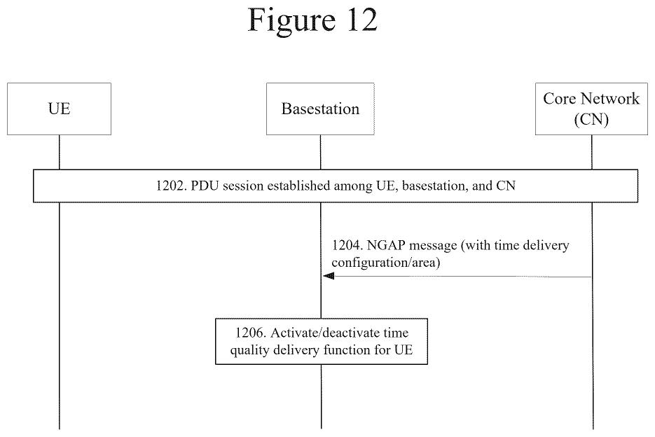

FIG. 12 shows an embodiment for starting/stopping of time delivery to user equipment (UE). In block 1202, the UE connects with the base station in a session among the core network (CN). In block 1204, the CN sends a NGAP message to the base station. The NGAP message may include time delivery configuration and/or time delivery area information described with respect to FIGS. 4-5. Further, the NGAP message in block 1204 includes a time delivery start/stop indication for the UE. This may be provided separate or together with the time delivery configuration and/or time delivery area information. In block 1206, upon receipt of the time delivery stop indication, the base station can deactivate the function of time quality delivery for this UE and stop sending time quality information to the UE. In block 1206, upon receipt of the time delivery start indication, the base station can activate the function of time quality delivery for this UE and start sending time quality information to the UE.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A wireless communication method comprising:
receiving, at a target base station, a time delivery configuration; and
determining, by the target base station, a delivery of time quality information based on the time delivery configuration.

2. The method of claim 1, wherein the delivery of time quality information is to a user equipment (UE).

3. The method of claim 2, wherein the receiving is during UE handover procedure or base station path switching procedure for UE handover.

4. The method of claim 1, wherein the time delivery configuration is received by the target base station from a source base station or a core network (CN).

5. The method of claim 1, wherein the time delivery configuration comprises: a clock quality level, wherein the clock quality level indicates what to provide to a user equipment (UE).

6. The method of claim 5, wherein the clock quality level comprises:
clock quality metrics or an indication for acceptance.

7. The method of claim 1, wherein the time delivery configuration comprises:
clock quality metrics; or
a clock quality acceptance criteria and an indication for acceptance.

8. The method of claim 7, wherein the clock quality acceptance criteria comprises at least one of the following: a parent time source, a traceability to Coordinated Universal Time (UTC), a traceability to Global navigation satellite system (GNSS), a synchronization state, a clock accuracy, or a frequency stability.

9. The method of claim 7, wherein the clock quality metrics comprises at least one of the following: clock accuracy, traceability to Coordinated Universal Time (UTC) and to Global navigation satellite system (GNSS), frequency stability, parent time source, or synchronization state.

10. The method of claim 7, wherein the indication for acceptance indicates a current timing synchronization status based on the clock quality acceptance criteria.

11. The method of claim 1, wherein the receiving, at the target base station, the time delivery configuration comprises:
receiving, at the target base station, a handover request message or a path switch acknowledge message from a core network (CN), wherein the handover request message or the path switch acknowledge message includes the time delivery configuration.

12. The method of claim 1, wherein the receiving, at the target base station, the time delivery configuration comprises:
receiving, at the target base station, a handover request message from a source basesation, wherein the handover request message includes the time delivery configuration.

13. A wireless communication method comprising:
transmitting, to a target base station, a time delivery configuration, wherein the time delivery configuration is used to determine a delivery of time quality information to a user equipment (UE).

14. The method of claim 13, wherein the transmitting is during UE handover procedure or base station path switching procedure for UE handover.

15. The method of claim 13, wherein the time delivery configuration comprises:
a clock quality level, wherein the clock quality level indicates what to provide to the UE.

16. The method of claim 15, wherein the clock quality level comprises:
clock quality metrics or an indication for acceptance.

17. The method of claim 13, wherein the time delivery configuration comprises:
clock quality metrics; or
a clock quality acceptance criteria and an indication for acceptance.

18. The method of claim 17, wherein one of:
the clock quality acceptance criteria comprises at least one of the following: a parent time source, a traceability to Coordinated Universal Time (UTC), a traceability to Global navigation satellite system (GNSS), a synchronization state, a clock accuracy, or a frequency stability, or
the clock quality metrics comprises at least one of the following: clock accuracy, traceability to UTC and to GNSS, frequency stability, parent time source, or synchronization state.

19. The method of claim 17, wherein the indication for acceptance indicates a current timing synchronization status based on the clock quality acceptance criteria.

20. A wireless communications apparatus comprising a processor and a memory, wherein the processor is configured to read code from the memory and implement a method recited in claim 1.
